(19) United States
(12) Patent Application Publication
(10) Pub. No.: US 2012/0279132 A1
(43) Pub. Date: Nov. 8, 2012

(54) TRANSIT WINDOW ASSEMBLY FOR VEHICLES

(75) Inventors: Roger Eldon Schamanek, Sterling Heights, MI (US); Kelly J. Harris, Lawrenceburg, TN (US); Danny Lee Kennedy, Lawrenceburg, TN (US)

(73) Assignee: Dura Global Technologies, LLC, Rochester Hills, MI (US)

(21) Appl. No.: 13/102,241

(22) Filed: May 6, 2011

(51) Int. Cl. B60J 5/00; B60J 10/02

(52) U.S. Cl. 49/381; 49/466; 49/465; 49/475.1; 49/383; 49/507

(57) ABSTRACT

A transit window assembly for a vehicle includes a panel. A support frame is attached to the panel. A base mount is removably attached to the support frame. A mounting frame is attached to the vehicle. The base mount is linked to mounting frame. A seal is positioned about the base mount and contacts the panel continuously sealing between the base mount and the panel. A rigid linkage removably connects the base mount to the support frame.

### FIELD OF THE INVENTION

The invention relates to improvements in passenger vehicle transit window assemblies.

### BACKGROUND OF THE INVENTION

Transit window assemblies may be used on various vehicles including buses, trains, recreational vehicles, as well as other vehicles. Transit windows are utilized in harsh use environments such as public transportation and other environments where the windows are exposed to environmental as well as physical abuse from passengers. Often such transit windows may need to be serviced to replace broken glass panels or remove graffiti from a portion of the window. There is therefore a need in the art for a transit window that is easily serviced without the need for complicated servicing requirements. There is also a need in the art for a transit window that is aesthetically pleasing while maintaining a separation between interior and exterior environments of the vehicle. There is also a need in the art for a transit window that includes components that may be easily coupled together and separated to allow for servicing of various components within the window assembly.

### SUMMARY OF THE INVENTION

In one aspect, there is disclosed a transit window assembly for a vehicle that includes a panel. A support frame is attached to the panel. A base mount is removably attached to the support frame. A mounting frame is attached to the vehicle. The base mount is linked to the mounting frame. A seal is positioned about the base mount and contacts the panel continuously sealing between the base mount and the panel.

In another aspect, there is disclosed a transit window assembly for a vehicle that includes a panel. A support frame is attached to the panel. Also included is a base mount and a rigid linkage removably connecting the base mount to the support frame. A mounting frame is attached to the vehicle. The base mount is linked to the mounting frame.

In a further aspect there is disclosed an egress transit window assembly for a vehicle that includes a panel. A support frame is attached to the panel. A base mount is provided with a rigid linkage removably connecting the base mount to the support frame. A mounting frame is attached to the vehicle. The base mount is coupled to pivoting structures that are linked to the mounting frame.

In another aspect, there is disclosed a non egress transit window assembly for a vehicle that includes a panel. A support frame is attached to the panel. Also provided is a base mount and a rigid linkage removably connecting the base mount to the support frame. A mounting frame is attached to the vehicle and the base mount is directly linked to the mounting frame.

### BRIEF DESCRIPTION OF THE DRAWINGS

FIG. 1 is a partial sectional view of a transit window assembly disclosing a lower section of an egress transit window;

FIG. 2 is a partial sectional view of a transit window assembly disclosing a non egress transit window;

FIG. 3 is a front view of an egress transit window;

FIG. 4 is a front view of an egress transit window;

FIG. 5 is a front view of an egress transit window;

FIG. 6 is a front view of non egress transit window;

FIG. 7 is a front view of a non egress transit window;

FIG. 8 is a front view of a non egress transit window;

FIG. 9 is a plan view of a transit window assembly including the panel and the discontinuous support frame.

### DETAILED DESCRIPTION OF THE PREFERRED EMBODIMENTS

Referring to the various figures, there is shown a transit window assembly 10 for a vehicle. The transit window assembly 10 includes a panel 15. The panel 15 may include various structures such as a glass sheet, plastic or other acrylic sheet, or a metal panel or other material. A support frame 20 is attached to the panel 15. A base mount 25 is removably attached to the support frame 20. A mounting frame 30 is attached to the vehicle. The base mount 25 is linked to the mounting frame 30. A seal 35 is positioned about the base mount 25 and contacts the panel 15 continuously sealing between the base mount 25 and the panel 15. The base mount 25 may be linked to the mounting frame 30 through an intermediate structure such as pivoting structures 95 or may be directly linked to the mounting frame 30, as will be discussed in more detail below.

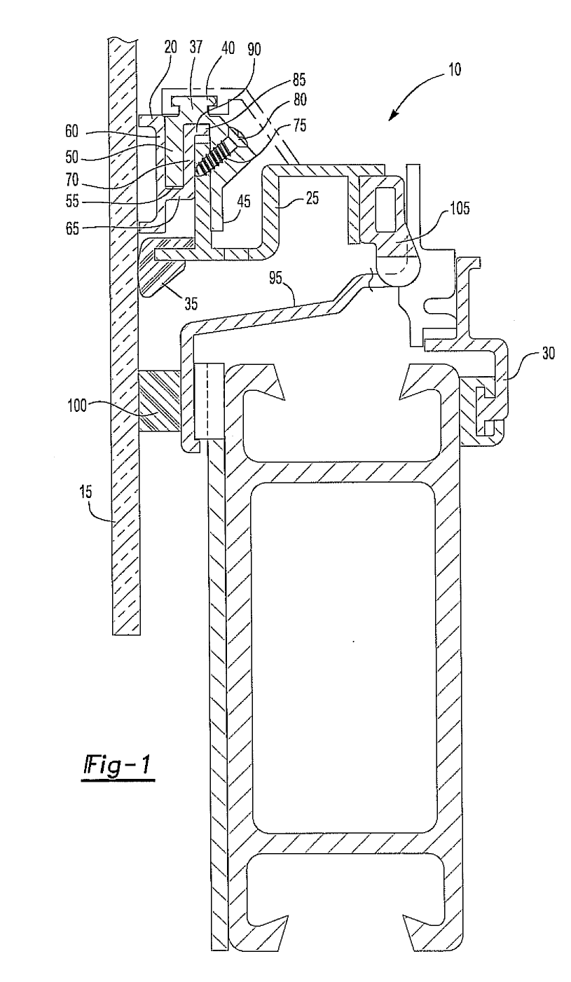

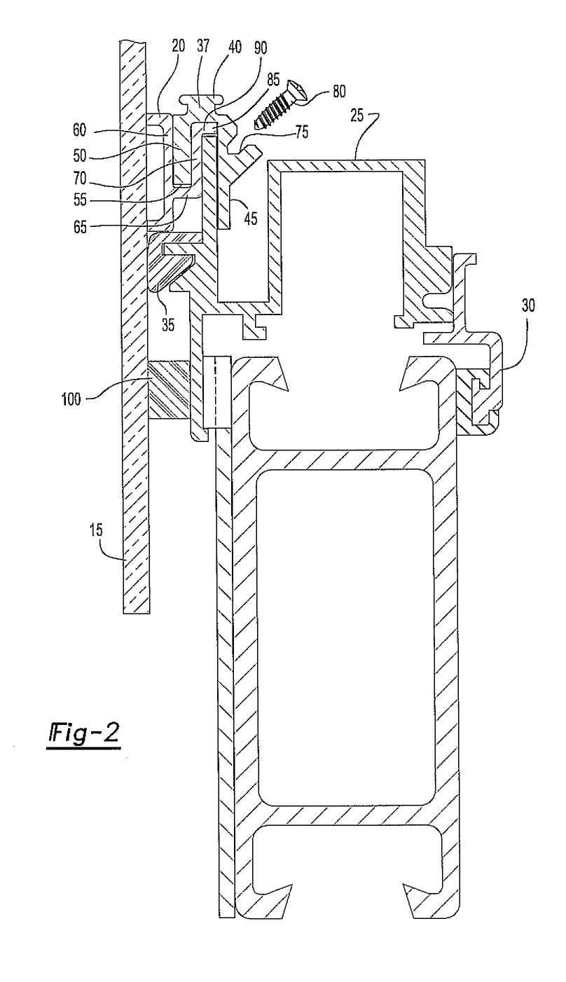

In one aspect, a rigid linkage 37 removably connects the base mount 25 to the support frame 20. The linkage 37 includes a u-shaped body 40 having a first leg 45 that is removably attached to the base mount 25 and a second leg 50 that is received in a slot 55 defined in the support frame 20. As can be seen in FIGS. 1 and 2, the support frame 20 includes a trough section 60 that receives an adhesive attaching the support frame 20 to the panel 15. The support frame 20 also includes a first leg portion 65 that extends from the trough section 60 and a second leg portion 70 that extends at an angle from the first leg portion 65 defining the slot 55. The linkage 37 includes an indentation 75 formed therein that receives a fastener 80 removably attaching the linkage 37 to the base mount 25. In one aspect, the indentation 75 may be formed at an angle to assist in decoupling the linkage 37 and the base mount 25. In this manner the fastener 80 may be removed without obstruction by structures within a vehicle such as seats or the like.

In one aspect, the support frame 20 includes a positioning datum 85 aligning a glazing attaching the panel 15 to the support frame 20. In one aspect, the second leg portion 70 includes a third leg portion 90 that extends at an angle from the second leg portion 70. The third leg portion 90 contacts the base mount 25 and linkage 37 aligning the panel 15 to the support frame 20 and providing a datum as described above.

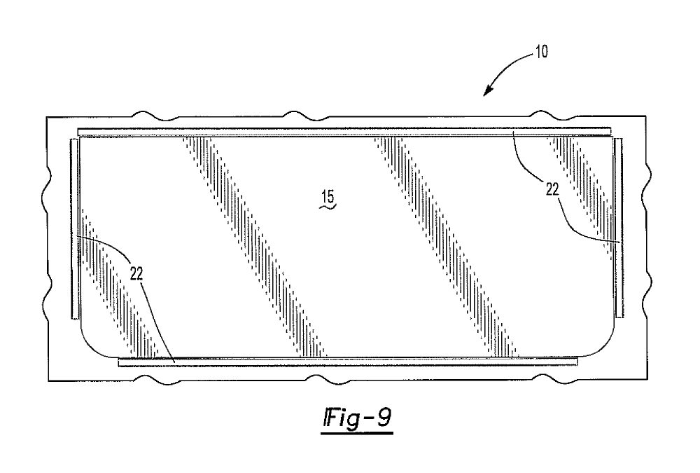

In one aspect, as best shown in FIG. 9 the support frame 20 may include a plurality of discontinuous components 22 that are linear. The plurality of discontinuous components 22 are separate components and not formed in one piece. The plurality of linear components 22 may be positioned and attached to the panel 15 along the straight portions of the panel boundary. In this manner, the support frame 20 may be easily manufactured without the need for forming curves or shapes that correspond to a complicated shape of the panel 15. Additionally, the support frame 20 may be easily positioned and attached along the straight portions of the panel 15. The seal 35 attached to the base mount 25 allows for the continuous seal of the panel 15 and base mount 25 even though the support frame 20 is discontinuous.

Again referring to FIG. 1, there is shown a transit window assembly 10 that is an egress assembly wherein the base mount 25 is coupled to pivoting structures 95 that are linked to the mounting frame 30. In one aspect, the egress window may be pivotal such that the panel 15 can be opened allowing occupants within a vehicle to exit the vehicle. In one aspect, the base mount 25 and the mounting frame 30 include pivoting structures 95 allowing pivotal movement of the panel 15.

Again referring to FIG. 1, the egress window assembly 10 may include additional seals such as a secondary seal 100 between the mounting frame 30 and the panel 15, as well as another seal 105 between the mounting frame 30 and the base mount 25. In this manner various components of the transit window assembly 10 remained sealed.

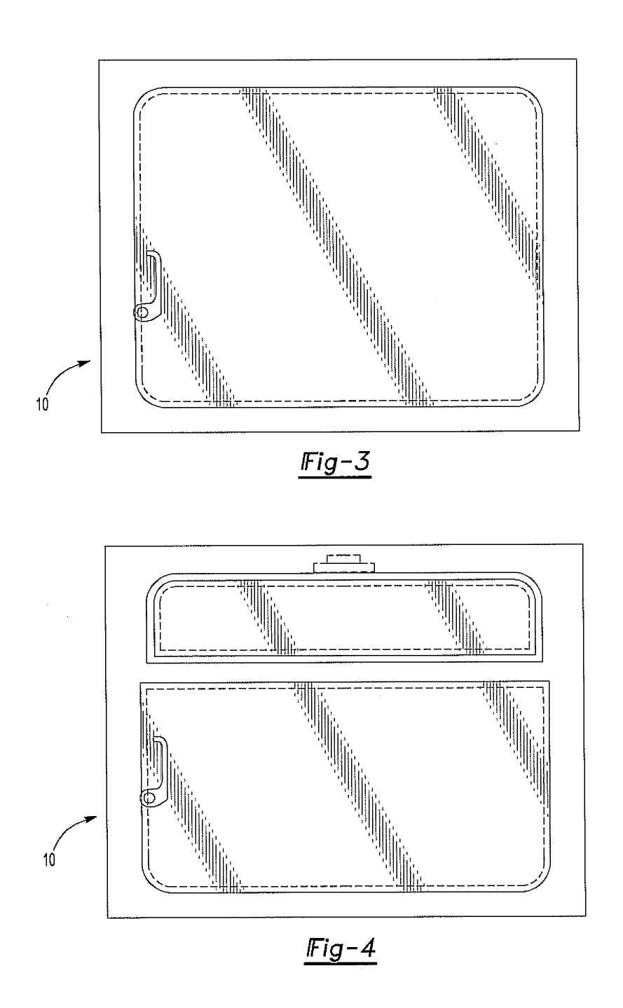

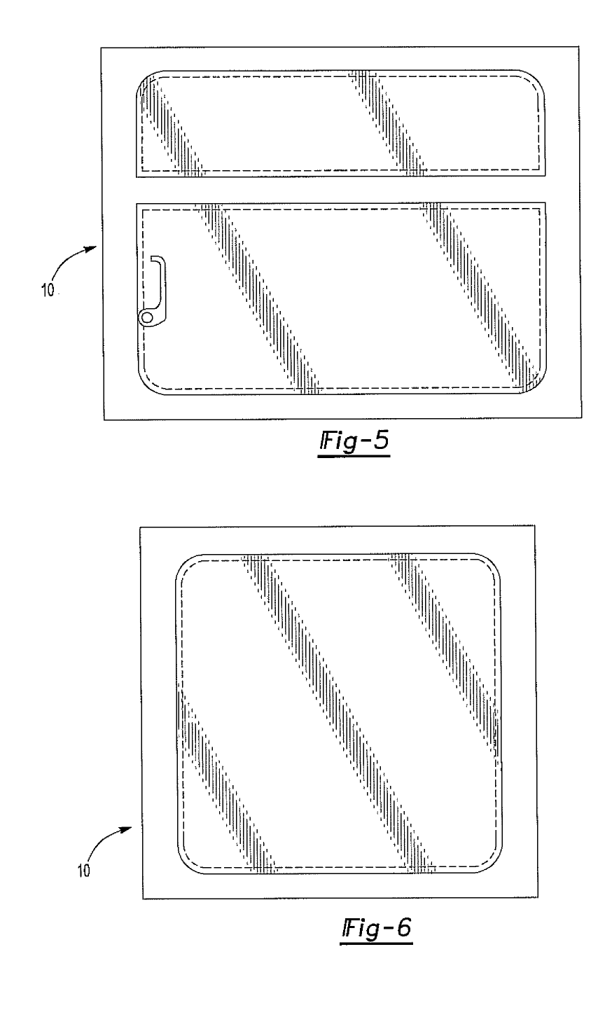

Various types of egress windows as disclosed in FIGS. 3-5 may be utilized. In one aspect the egress window may include a latching structure 110 that allows the egress window to be opened and closed by an occupant of the vehicle. Various latching structures may be utilized, such as handles, buttons or any other latching structure. Various shapes and structures of the panel 15 are shown in FIGS. 3-5. In one aspect, the egress window assembly may include a full panel, a destination type panel, or a transom type panel, as shown in FIGS. 3, 4 and 5 respectively.

Referring to FIG. 2, there is shown a transit window assembly 10 for a non egress window assembly. As with the previously described egress transit window assembly 10 of FIG. 1, there is disclosed a panel 15 and a support frame 20 attached to the panel 15. A base mount 25 is provided with the base mount 25 linked to a mounting frame 30 that is connected to the vehicle. In one aspect the base mount is directly linked to the mounting frame 30 as shown in the figure. As previously described, a seal 35 is positioned about the base mount 25 and contacts the panel 15 continuously sealing between the base mount 25 and the panel 15. Additionally, as previously described, a rigid linkage 37 removably connects the base mount 25 to the support frame 20.

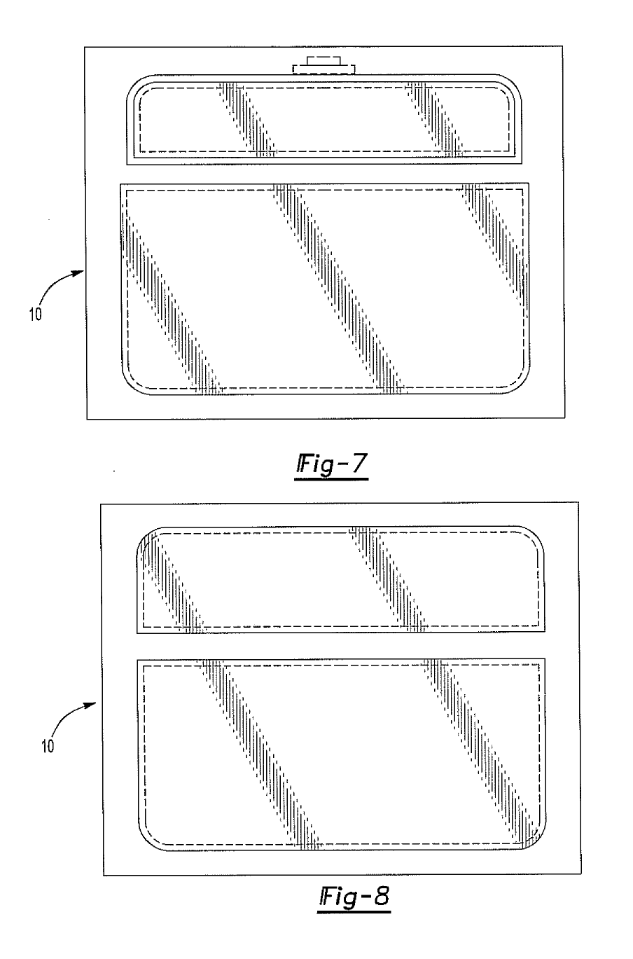

As with the previously described egress window assembly, various types of non egress window assemblies may be utilized. For example, as shown in FIG. 6, a full panel non egress window assembly may be utilized. Additionally, as shown in FIGS. 7 and 8, destination type non egress window assemblies and transom type non egress window assemblies may also be utilized.

The transit window assembly 10 provides a serviceable flush window assembly for use in transit applications such as in a bus, train, or other types of vehicles. The serviceable transit window assembly 10 provides for a simplified procedure when replacing the panel 15 due to damage such as graffiti, breakage or abuse by an occupant of the vehicle. In one aspect, a party servicing the vehicle may easily remove the panel 15 by removing the fastener 80 that passes through the rigid linkage 37 and attaches the base mount 25 to the support frame 20. The linkage 37 may then be lifted or removed from the slot 55 formed in the support frame 20 allowing the panel 15 and support frame 20 to be easily removed from a window opening. A replacement panel 15 attached to another support frame 20 may easily be reattached to the base mount 25 by coupling and positioning the support frame 20 utilizing the rigid linkage 37 that is then attached to the base mount 25 utilizing the fastener 80 that passes through the rigid linkage 37. The seal 35 that is attached to the base mount 25 contacts the panel 15 as the support frame 20 is attached to the base mount and seals the panel 15 and base mount 25. In this manner, a simplified procedure is provided in which a seal 35 does not need to be replaced in a complicated assembly such as when a seal is positioned between or attached to other components of a window assembly.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A transit window assembly for a vehicle comprising:
a panel;
a support frame attached to the panel;
a base mount removably attached to the support frame;
a mounting frame attached to the vehicle, the base mount linked to the mounting frame;
a seal positioned about the base mount and contacting the panel continuously sealing between the base mount and panel.

2. The transit window assembly of claim 1 including a rigid linkage connecting the base mount to the support frame.

3. The transit window assembly of claim 2 wherein the linkage includes a u-shaped body having a first leg removably attached to the base mount and a second leg received in a slot defined in the support frame.

4. The transit window assembly of claim 2 wherein the rigid linkage includes an angled indentation receiving a fastener removably attaching the linkage to the base mount.

5. The transit window assembly of claim 1 wherein the support frame includes a positioning datum formed thereon aligning a glazing attaching the panel to the support frame.

6. The transit window assembly of claim 1 wherein the support frame includes a trough section receiving an adhesive attaching the support frame to the panel, the support frame also including a first leg portion extending from the trough section and a second leg portion extending at an angle from the first leg portion defining a slot.

7. The transit window assembly of claim 6 wherein the second leg portion includes a third leg portion extending at an angle from the second leg portion, the third leg portion contacting the base mount and linkage aligning a glazing attaching the panel to the support frame.

8. The transit window assembly of claim 1 wherein the transit window assembly is an egress assembly wherein the base mount is coupled to pivoting structures that are linked to the mounting frame.

9. The transit window assembly of claim I wherein the transit window assembly is a non egress assembly wherein the mounting frame is directly linked to the base mount.

10. The transit window assembly of claim I wherein the support frame includes a plurality of discontinuous linear structures positioned about the panel and attached along the panel on straight portions of the panel.

11. A transit window assembly for a vehicle comprising:
a panel;
a support frame attached to the panel;
a base mount;
a rigid linkage removably connecting the base mount to the support frame; and
a mounting frame attached to the vehicle, the base mount linked to the mounting frame.

12. The transit window assembly of claim 11 including a seal positioned about the base mount and contacting the panel continuously sealing between the base mount and panel.

13. The transit window assembly of claim 11 wherein the linkage includes a u-shaped body having a first leg removably attached to the base mount and a second leg received in a slot defined in the support frame.

14. The transit window assembly of claim 11 wherein the rigid linkage includes an angled indentation receiving a fastener removably attaching the linkage to the base mount.

15. The transit window assembly of claim 11 wherein the support frame includes a positioning datum formed thereon aligning a glazing attaching the panel to the support frame.

16. The transit window assembly of claim 11 wherein the support frame includes a trough section receiving an adhesive attaching the support frame to the panel, the support frame also including a first leg portion extending from the trough section and a second leg portion extending at an angle from the first leg portion defining a slot.

17. The transit window assembly of claim 16 wherein the second leg portion includes a third leg portion extending at an angle from the second leg portion, the third leg portion contacting the base mount and linkage aligning a glazing attaching the panel to the support frame.

18. The transit window assembly of claim 11 wherein the transit window assembly is an egress assembly wherein the base mount is coupled to pivoting structures that are linked to the mounting frame.

19. The transit window assembly of claim 10 wherein the transit window assembly is a non egress assembly wherein the mounting frame is directly coupled to the base mount.

20. The transit window assembly of claim 11 wherein the support frame includes a plurality of discontinuous linear structures positioned about the panel and attached along the panel on straight portions of the panel.

21. An egress transit window assembly for a vehicle comprising:
a panel;
a support frame attached to the panel;
a base mount;
a rigid linkage removably connecting the base mount to the support frame; and
a mounting frame attached to the vehicle, the base mount coupled to pivoting structures linked to the mounting frame.

22. The transit window assembly of claim 21 including a seal positioned about the base mount and contacting the panel continuously sealing between the base mount and panel.

23. A non egress transit window assembly for a vehicle comprising:
a panel;
a support frame attached to the panel;
a base mount;
a rigid linkage removably connecting the base mount to the support frame; and
a mounting frame attached to the vehicle, the base mount directly linked to the mounting frame.

24. The transit window assembly of claim 23 including a seal positioned about the base mount and contacting the panel continuously sealing between the base mount and panel.
